(19) United States
(12) Patent Application Publication
(10) Pub. No.: US 2025/0334145 A1
(43) Pub. Date: Oct. 30, 2025

(54) COUPLING DEVICE

(71) Applicant: MIichael DILEO, BROOKHAVEN, NY (US)

(72) Inventor: MIichael DILEO, BROOKHAVEN, NY (US)

(21) Appl. No.: 19/189,052

(22) Filed: Apr. 24, 2025

Related U.S. Application Data
(60) Provisional application No. 63/638,802, filed on Apr. 25, 2024.

(51) Int. Cl. F16B 45/02

(52) U.S. Cl. CPC F16B 45/026; F16B 45/029

(57) ABSTRACT

A clip that requires a single action or one movement of a hand(s) to lock and unlock, and as such no secondary action is required to lock and unlock the clip. By holding the clip in a user's hand, squeezing the clip the clip and in turn applying a force to the clip, the clip can be unlocked. Upon releasing the force applied to the clip, the clip will automatically return to a closed, locked state.

### CROSS-REFERENCE TO RELATED APPLICATION

This patent application claims benefit to U.S. Provisional Patent Application No. 63/638,802, filed Apr. 25, 2024, which is hereby incorporated by reference in its entirety as part of the present disclosure.

### FIELD OF THE INVENTION

The present disclosure generally relates generally to a coupling device, and more specifically to a clip that does not require secondary action or multiple movements of a hand(s) to lock and/or unlock.

### BACKGROUND

In general, clips that include a spring-loaded gate and are lockable are well-known. However, existing clips commonly require a secondary action or multiple movements of a hand(s) to lock and unlock. That is, existing clips require a user to unlock the clip and then relock the clip or vice versa. No clip allows for unlocking and relocking in a single action or one simultaneous motion of a hand.

### SPECIFICATION

In an embodiment, the present disclosure is directed to a coupling device or clip that requires only a single action or one simultaneous motion of a hand to lock and unlock. As such, no secondary action or multiple movements of a hand(s) is required to lock and unlock the clip. A user can hold the clip in their hand, squeeze the clip and in turn apply a force to the clip to unlock the clip. Upon releasing the force applied to the clip, the clip will automatically return to a closed, locked state.

The clip can be used for a variety of purposes and activities. For example, the clip can be a connection mechanism between a collar or harness for an animal (e.g., dog) and a leash, rope or the like.

In an embodiment, the coupling device or clip can include a chassis, a swing arm pivotably fixed to the chassis, a release arm that is pivotably fixed to the chassis, a first spring that is fixed at a first end to the chassis and at a second end to the release arm, a second spring that is fixed in part to the chassis, a crossbar that is fixed to the swing arm, a first shroud that extends over a first side of the chassis, a second shroud that extends over a second side of the chassis and a rotatable attachment.

In an embodiment, the chassis can include a main body that is generally C-shaped as defined by a first arm that is delimited at a first end and a second end thereof, a second arm that is contiguous to the first arm and extends at an angle therefrom, a third arm that is spaced from the first arm and extends at an angle from the second arm substantially parallel to the first arm, and a fourth arm that extends at an angle from the third arm.

A plurality of through-holes can extend through the main body. A projection or nib can extend at an angle from the second arm of the main body towards the third arm. A recess can extend from an external surface of the second arm of the main body inwardly. A delimiting end of the fourth arm can include an angled projection that extends toward the third arm with a cavity located directly beneath the angled projection.

The release arm can include a main body with a first slot and a second slot that extend at angles (i.e., 45 degrees), a contact surface and a projection or nib that can extend from the main body of the release arm. The release arm can be fixed to the chassis by fasteners (e.g., steel pins) that extend through the first slot and the second slot.

The swing arm can include a main body with an opening though which fasteners (e.g., steel pins) extend to fix the swing arm to the chassis, and a contact surface that extends at an angle away from the main body.

The crossbar can include a slotted opening therein, a projection (e.g., trapezoidal shape) that extends from an outer edge of a top surface and a projection extends from an outer edge of the lower surface of the crossbar forming a cavity between the outer edge of the lower surface and the projection. The crossbar can be fixed to the swing arm by a fastener (e.g., steel pin). The crossbar is configured to prohibit motion of the swing arm in a first, locked position.

In an embodiment, the projection of the crossbar and the projection at the delimiting end of the fourth arm of the chassis are configured to interact with each other to form an interference fit in the first, locked position. The interlocking of the crossbar with the chassis below the swing arm distributes a load equally along both sides of the chassis in the first, locked position.

In an embodiment, the first spring extends over the projection of the release arm and the projection of the chassis. The first spring can, for example, be a compression spring. In an alternate embodiment, a coil spring can be contactable with the release arm and fixed with the clip by a fastener.

In an embodiment, the second spring can be fixed to the chassis and contactable with the swing arm. Here, the spring can be, for example, a swing arm spring. Alternatively, the second spring can be a coil spring that is contactable with the swing arm.

The first spring and the second spring ensure that when no force is applied to the release arm and the swing arm, respectively, that the release arm and the swing arm remain in a closed or locked position. When a force is applied to the swing arm in a first direction and a force is applied the release arm in a second direction that is opposite that of the swing arm, the first spring and the second spring compress and allow both the swing arm, the crossbar and the release arm to move, creating a gap to insert an object within the clip. Thus, the springs along with the cross bar control the motion of the release arm and the swing arm.

The first shroud is configured to extends substantially over a first side of the chassis and is fixed thereto by one or more fasteners, and the second shroud is configured to extend substantially over a second side of the chassis and is fixed thereto by one or more fasteners.

In another embodiment a clip assembly can include a chassis, a swing arm that is pivotably fixed to the chassis, a release arm that is pivotably fixed to the chassis, a first spring, a second spring, a crossbar that is fixed to the swing arm, a first shroud that extends over a first side of the chassis, a second shroud that extends over a second side of the chassis and a rotatable attachment secured to the clip assembly. The first spring and the second spring can be coil springs. The first coil spring can have an arm that is configured to contact and apply a force to the release arm. The second spring can have an arm that is configured to apply a force on the swing arm. The springs are configured to ensure that the clip remains in a closed position when a force is not applied thereto, but allow for movement of the swing arm, the release arm and the cross bar upon a force being applied to the release arm and swing arm.

In another embodiment, a clip assembly includes a chassis, a swing arm that is pivotably fixed to the chassis, a release arm that is pivotably fixed to the chassis, a spring that is fixed in place by a fastener, a crossbar that is fixed to the swing arm, a first shroud that extends over a first side of the chassis, a second shroud that extends over a second side of the chassis and an rotatable attachment.

The spring can be a coil spring that has an arm that is configured to contact and apply a force to the swing arm. The spring is configured to ensure that the clip remains in a closed position when a force is not applied thereto, but allow for movement of the swing arm, the release arm and the cross bar upon a force being applied to the release arm and swing arm.

In yet another embodiment a clip assembly includes a chassis, a swing arm pivotably fixed to the chassis, a release arm that is pivotably fixed to the chassis, a spring, a cross bar that is fixed to the swing arm, a first shroud that extends over a first side of the chassis, a second shroud that extends over a second side of the chassis and a rotatable attachment. Here, the spring can be a coil spring, which has a first arm that extends in a first direction and from which a first projection extends that is configured to apply a force to the release arm and a second arm that extends in a second direction and from which a second projection extends that is configured to apply a force on the swing arm. The spring is configured to ensure the clip remains in a closed position when a force is not applied thereto, but allow for movement of the swing arm, the release arm and the cross bar upon a force being applied to the release arm and swing arm.

In another embodiment, a clip assembly includes a chassis, a swing arm that is pivotably fixed to the chassis, a release arm that is pivotably fixed to the chassis, a first spring that is fixed at a first end to the chassis and in contact with the release arm at a second end thereof, a second spring that is fixed at a first end to the chassis and in contact with the swing arm at a second end thereof, a crossbar that is slidably fixed to the chassis and fixed to the swing arm, a first shroud that extends over a first side of the chassis, a second shroud that extends over a second side of the chassis and a rotatable attachment.

The chassis can be generally C-shaped as defined by a first arm that includes a first projection and second projections that are spaced from each other forming a gap therebetween and delimit the first arm at a first end of the chassis, a second arm that is contiguous to the first arm and extends at an angle therefrom, a third arm that is spaced from the first arm and extends at an angle from the second arm, substantially parallel to the first arm, and a fourth arm that extends at an angle from the third arm. The second arm can include an opening in which the swing arm is arranged and a slot in which the crossbar is arranged and slidably fixed to the chassis. A delimiting end of the fourth arm of the chassis can include an angled projection that extends toward the third arm with a cavity located directly beneath the angled projection. A projection can extend from the chassis that includes a plurality of openings.

The release arm can include a main body with an opening and a slot, a first projection that extends from the main body of the release arm in a first direction and a second projection that extends from the main body of the release arm in a second direction. The release arm can be rotatably fixed to the chassis by fasteners (e.g., steel pins) that extend through the opening and the slot.

The swing arm can include a main body that is delimited at a first end which is arrangeable within the gap between the first and second projections of the first arm of the chassis and a first opening that is spaced from the first end though which a fastener extends to rotatably fix the swing arm to the chassis. A first arm can extend from a first side of the main body and a second arm can extend from a second side of the main body. The arms form a contact surface on an external surface of the swing arm and a first groove an internal surface of the swing arm in which the second spring is arranged and contactable with the swing arm. The main body and the arms form a second groove at a second end of the swing arm in which the crossbar is arranged. A second opening extend through the swing arm near the second end thereof and through which another one of the fasteners extends to fix the swing arm to the crossbar. The second end of the swing arm contacts an inner surface of the fourth arm in a first, closed position, and the second groove is configured such that the angled projection of the fourth arm extends within the second groove in the first, closed position.

The crossbar can include a slotted opening, a first projection that extends from an outer edge of a top surface and a second projection extends from an outer edge of the lower surface of the crossbar forming a cavity. The crossbar prohibits motion of the swing arm in the first closed, position.

The second projection of the crossbar and the projection at the delimiting end of the fourth arm of the chassis can be configured to interact with each other to form an interference fit in the first, closed position. The interlocking of the crossbar with the chassis near the distal end the swing arm distributes a load equally along both sides of the chassis in the first, closed position.

The first spring, which can, for example, be a compression spring, can be delimited at a first end and a second end and extends to form a U-Shape between the first and second end of the spring which contacts and remains in contact with the release arm. The first end of the first spring is fixed within a first side of a first one of the openings of the projection that extends from the crossbar and the second end of the first spring is fixed within a second side of a first one of the openings of the projection that extends from the crossbar. The second spring, which can, for example, be a compression spring, is delimited at a first end and a second end and extends to form a U-Shape between the first and second end of the spring, which contacts and remains in contact with the swing arm. The first end of the second spring is fixed within a second one of the openings of the projection that extends from the crossbar and the second end of the second spring is fixed within a third one of the openings of the projection that extends from the crossbar.

The first spring and the second spring ensure that when no force is applied to the release arm and the swing arm, respectively, that the release arm and the swing arm remain in a closed or locked position.

In an embodiment, to unlock the clip, a force is applied the release arm in a first direction and a force can then or simultaneously applied the swing arm in a second direction that is opposite that of the release arm. When a force is applied to the release arm and the swing arm, the first spring and the second spring compress and allow both the swing arm, the crossbar and the release arm to move and in turn create a gap between the lower end of the swing arm and the angled projection of the chassis to allow an object to be inserted or removed within the clip. When no force is applied to the release arm, the swing arm will not be able to move further in a direction toward the release arm to create a larger gap and when a force is no longer applied to the swing arm as well, the clip will return to the first closed or locked position.

In an embodiment, the rotatable attachment is arranged within the recess that extends from an external surface of the second arm of the main body inwardly and can swivel or rotate within the recess, as desired. The attachment includes a handle with an opening that an object (e.g., a rope, leash, etc.) can extend therethrough, a neck extends from the handle and a circular disk extends from the neck.

The components of the clip can, for example, be manufactured by injection molding, carbon fiber, etc. Components can alternatively or in addition be comprised of stainless steel and/or other high strength materials. The combination of materials such as carbon fiber and stainless steel allow for the clip to be both robust in strength and light-weight.

### BRIEF DESCRIPTION OF THE DRAWINGS

FIG. 1 is a front view of a clip according to according to an embodiment of the present disclosure;

FIG. 2 is a front view of the clip of FIG. 1 with a shroud removed according to an embodiment of the present disclosure;

FIG. 3 is front view of the clip of FIG. 1 with features removed to show internal details of the clip according to an embodiment of the present disclosure;

FIG. 4 is a front view showing the interaction of the chassis and cross bar of the clip of FIG. 1 in a closed position according to an embodiment of the present disclosure;

FIG. 5 is an assembly view of the clip of FIG. 1 according to an embodiment of the present disclosure;

FIG. 6 is a perspective view of a clip assembly with a shroud removed according to another embodiment of the present disclosure;

FIGS. 7-22 are various views of a clip assembly according to an embodiment of the present disclosure;

FIG. 23 is a perspective view of a clip assembly according to according to another embodiment of the present disclosure;

FIG. 24 is a front view of the clip assembly of FIG. 23;

FIG. 25 is another front view of the clip assembly of FIG. 23; and

FIGS. 26-32 are various views of a clip assembly and components thereof according to another embodiment of the present disclosure.

### DETAILED DESCRIPTION OF EMBODIMENTS OF THE INVENTION

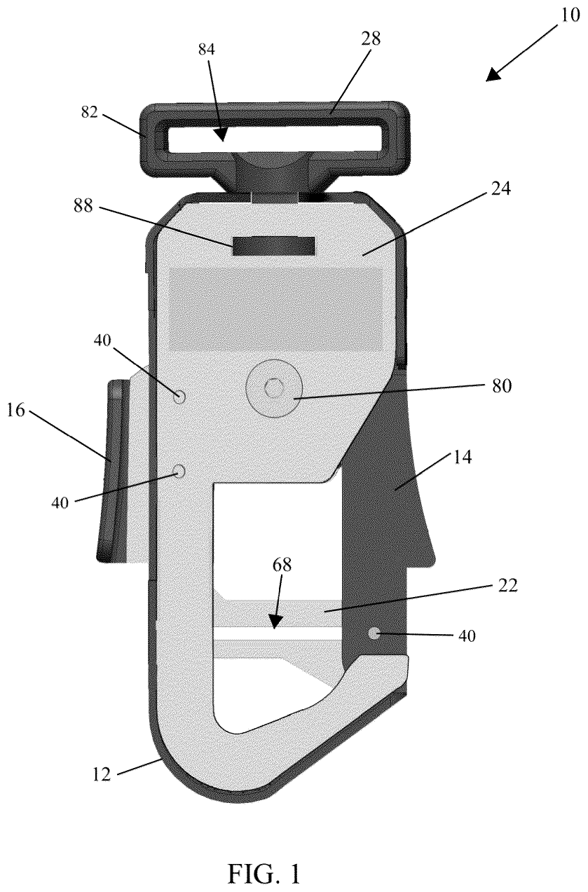

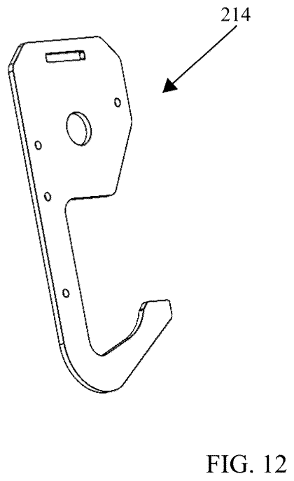

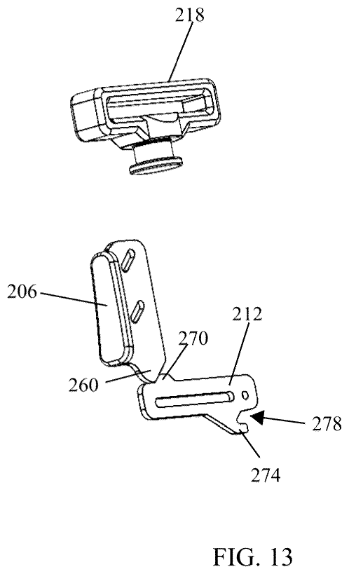

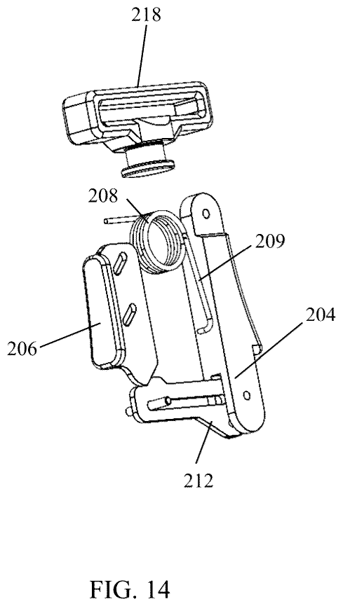

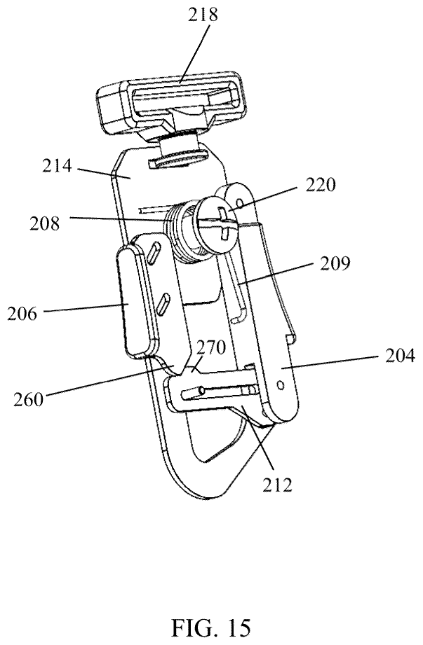

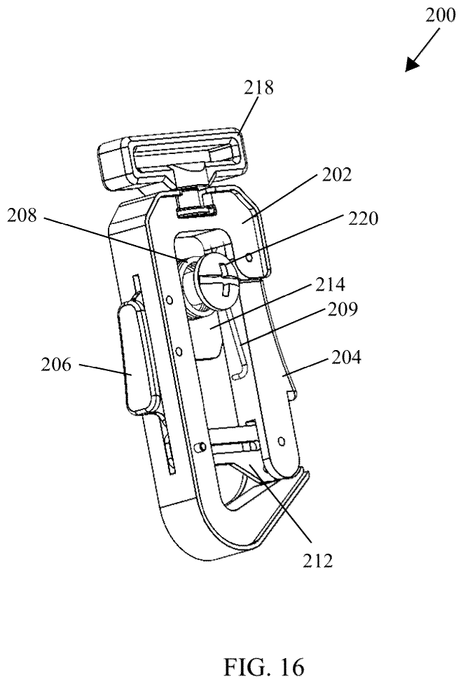

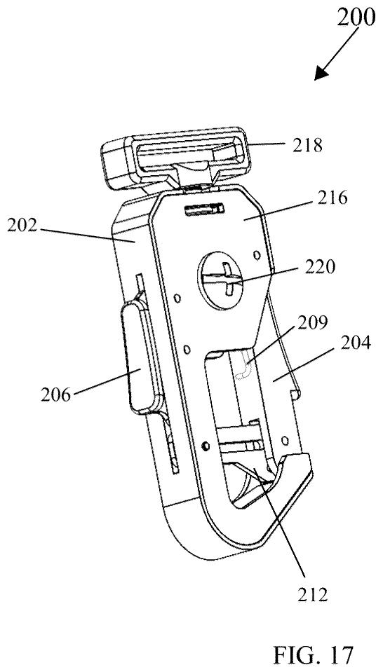

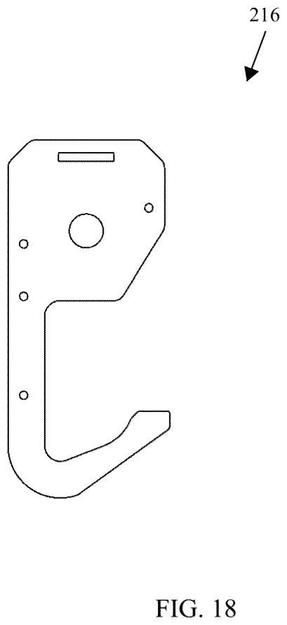

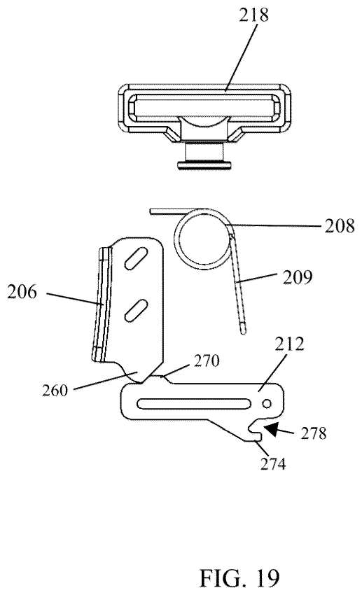

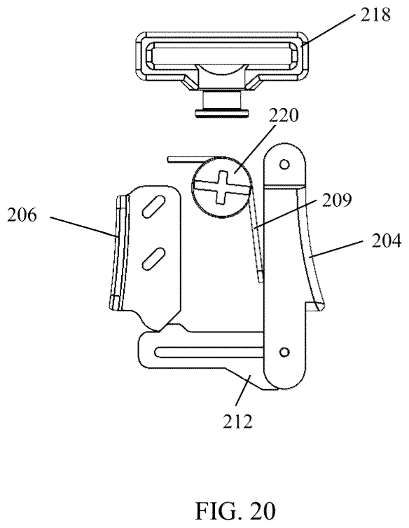

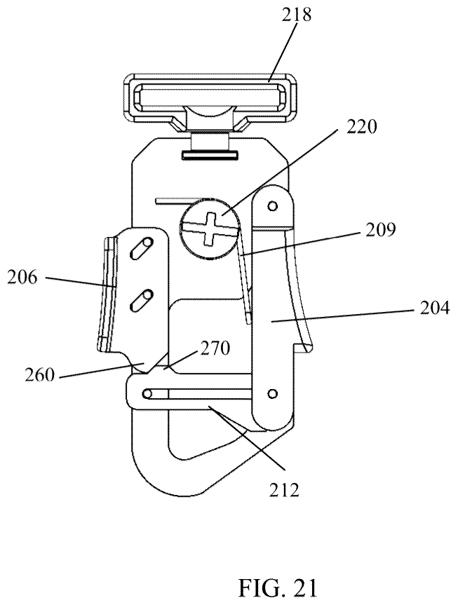

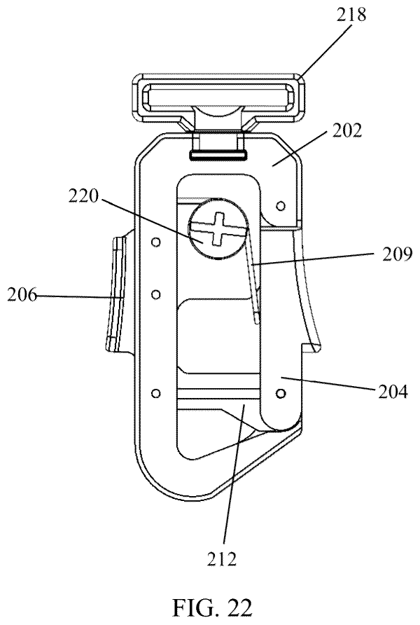

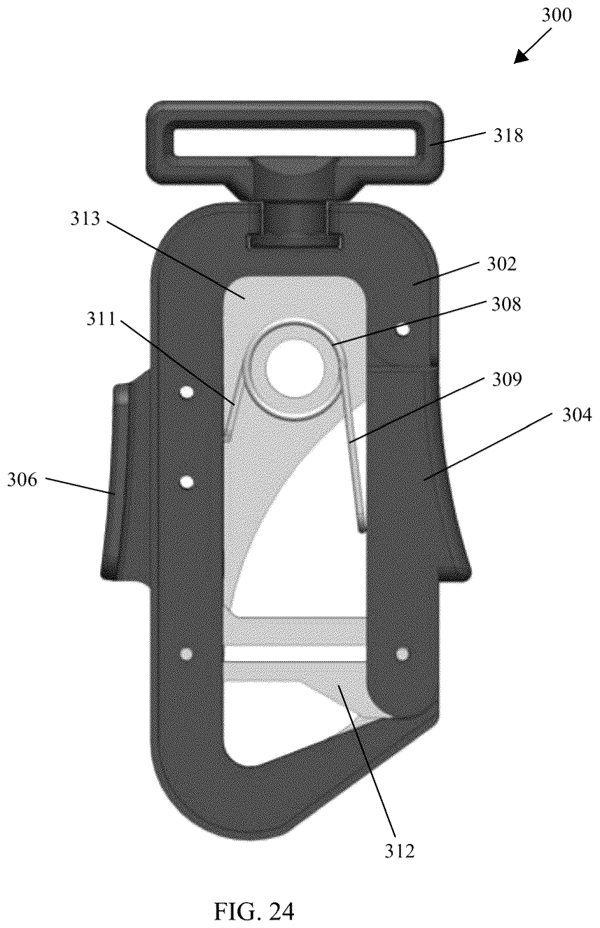

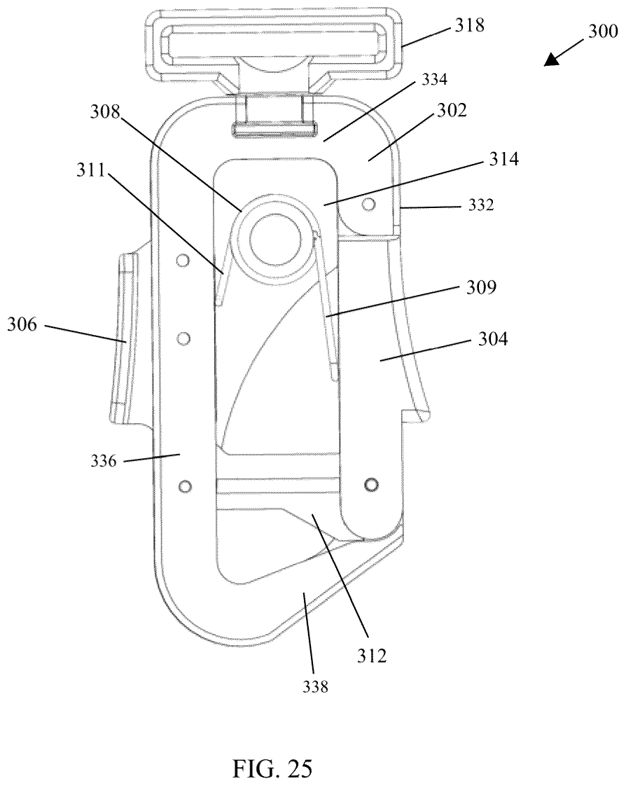

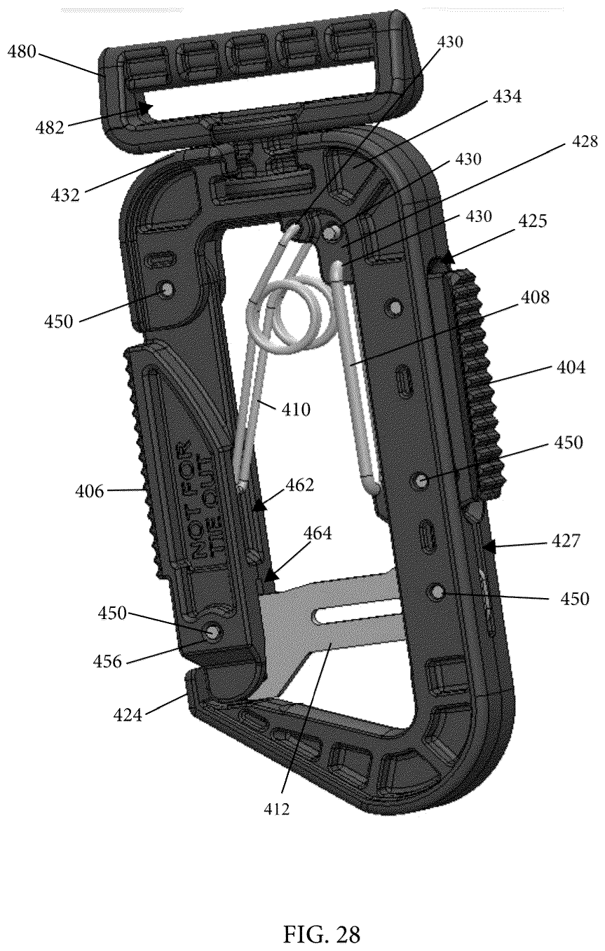

With reference now to the drawings and in particular FIGS. 1-32, embodiments of a coupling device or clip of the present disclosure, which is generally designated by reference numerals 10, 100, 200, 300, 400 will be described.

The clip 10, 100, 200, 300, 400, which is locked in a first closed or locked state, is configured to ensure that the clip 10, 100, 200, 300, 400 will not open accidently. The clip 10, 100, 200, 300 requires only a single action or single movement of a hand(s) to lock and unlock, and as such no secondary action or multiple movements of a hand(s) is required to lock and unlock the clip 10, 100, 200, 300, 400. By holding the clip 10, 100, 200, 300, 400 in a user's hand, squeezing the clip 10, 100, 200, 300, 400, and in turn applying a force to the clip 10, 100, 200, 300, 400, the clip 10, 100, 200, 300, 400 can be unlocked. When a force is applied to the clip 10, 100, 200, 300, 400, the clip 10, 100, 200, 300, 400, the clip 10, 100, 200, 300, 400 moves to an open or second state. Upon releasing the force applied to the clip 10, 100, 200, 300, the clip 10, 100, 200, 300, 400 will automatically return to the first closed or locked state.

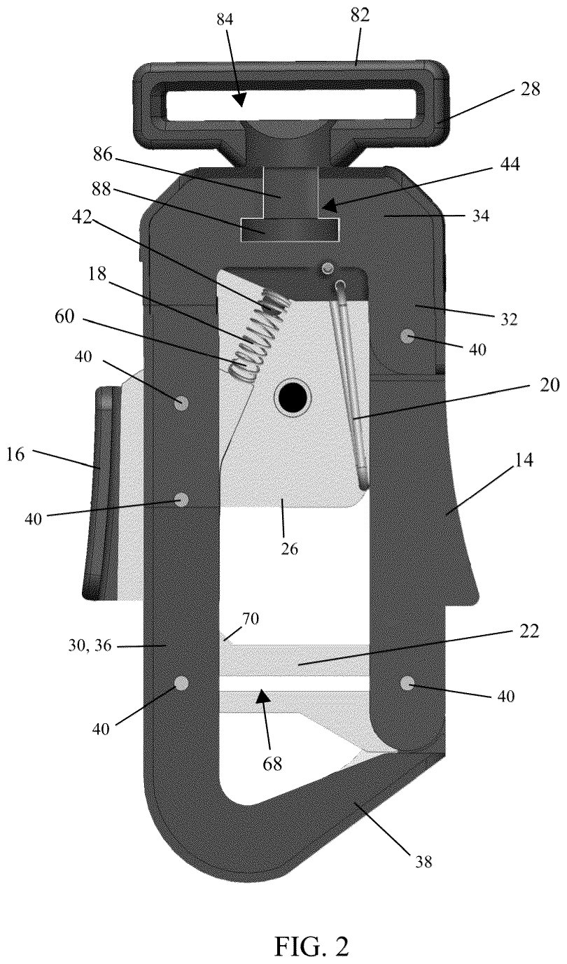

As can be seen in FIGS. 1-5, the clip 10 includes a chassis or housing 12, a swing arm 14 that is pivotably fixed to the chassis 12, a release arm 16 that is pivotably fixed to the chassis 12, a first spring 18 (see FIG. 2) that is fixed at a first end to the chassis 12 and at a second end to the release arm 16, a second spring 20 (see FIG. 2) that is fixed in part to the chassis 12, a crossbar 22 that is fixed to the swing arm 14 and movably fixed to the chassis 12, a first shroud 24 that extends over a first side of the chassis 12, a second shroud 26 that extends over a second side of the chassis and a rotatable attachment 28.

As shown in FIGS. 2-5, the chassis 12 includes a main body 30 that is generally C-shaped as defined by a first arm 32 that includes a first projection 33 and a second projection 35 that are spaced from each other to form a gap 37 therebetween and delimit the first arm 32 at a first end of the chassis 12, a second arm 34 that is contiguous to the first arm 32 and extends at an angle therefrom, a third arm 36 that is spaced from the first arm 32 and extends at an angle from the second arm 34 substantially parallel to the first arm 32, and a fourth arm 38 that extends at an angle from the third arm 36. The second arm 34 includes an opening 39 in which the swing arm 14 is arranged and a slot 41 in which the crossbar 22 is arranged and slidably fixed to the chassis 12.

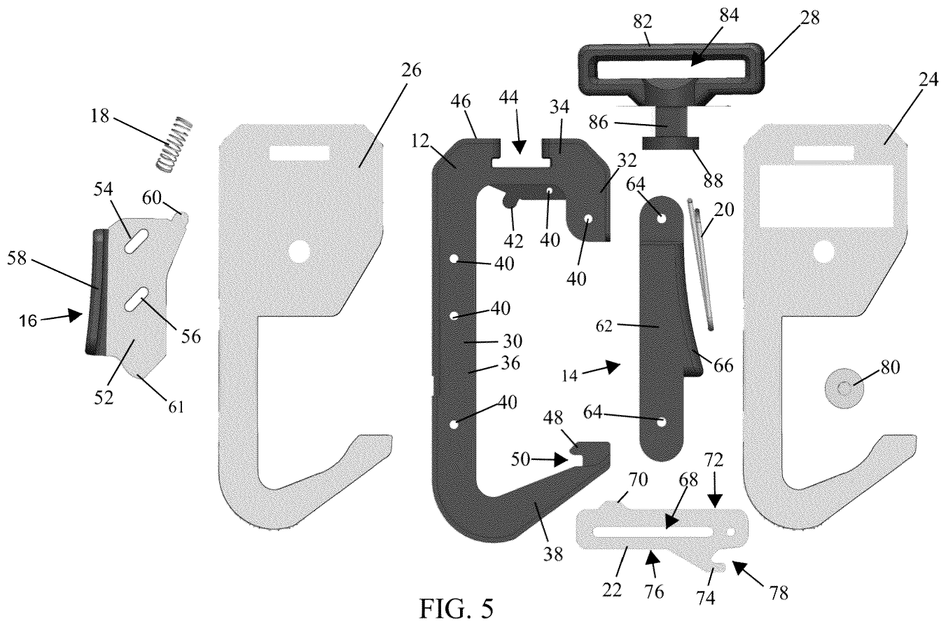

A plurality of through-holes 40 extend through the main body 30. A projection or nib 42 extends at an angle from the second arm 34 of main body 30 toward the third arm 36. A recess 44 extends from an external surface 46 of the second arm 34 of the main body 30 inwardly. A delimiting end of the fourth arm 38 includes an angled projection 48 that extends toward the third arm 36 with a cavity 50 (see FIG. 5) located directly beneath the angled projection 48.

As seen, for example, in FIG. 5, the release arm 16 includes a main body 52 with a first slot 54 and a second slot 56, that extend at angle (i.e., 45 degrees), a contact surface 58, a first projection or nib 60 that extends from the main body 52 of the release arm 16 and a second projection 61 that extends from the main body 52 in a direction that is different from that of the first projection 60. The release arm 16 is fixed to the chassis 12 by fasteners (e.g., steel pins) that extend through the first slot 54 and the second slot 56.

As seen, for example, in FIG. 5, the swing arm 14 includes a main body 62 with an opening 64 though which fasteners (e.g., steel pins) extend to fix the swing arm 14 to the chassis 12, and a contact surface 66 that extends at an angle away from the main body 62.

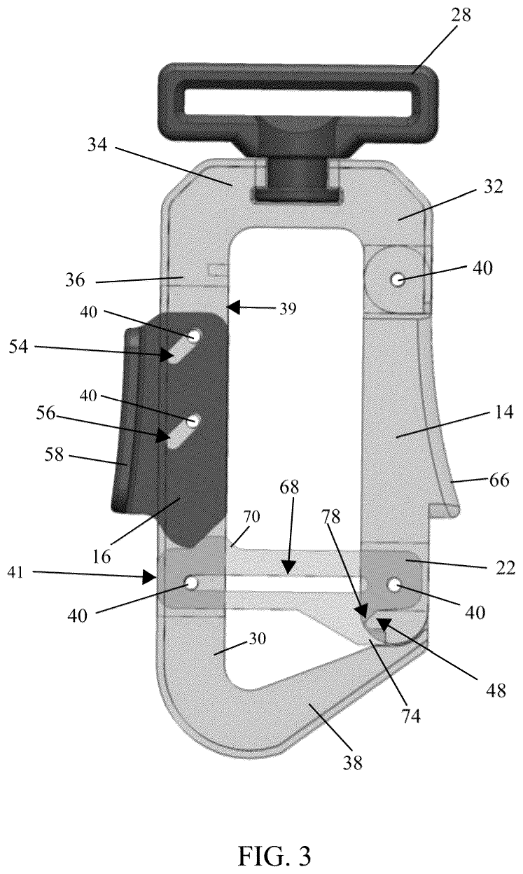

As seen, for example, in FIG. 5, the crossbar 22 includes a slotted opening 68 therein, a projection 70 (e.g., trapezoidal shape) extends from an outer edge of a top surface 72 and a projection 74 extends from an outer edge of the lower surface 76 of the crossbar 22 forming a cavity 78 between the outer edge of the lower surface 76 and the projection 74. The crossbar 22 is fixed to the swing arm 14 by a fastener (e.g., steel pin), and configured to extend through an opening in chassis 12 and the swing arm 14 (see FIG. 3). The cross bar 22 prohibits motion of the swing arm 14 and the release arm 16 in the first closed or locked state.

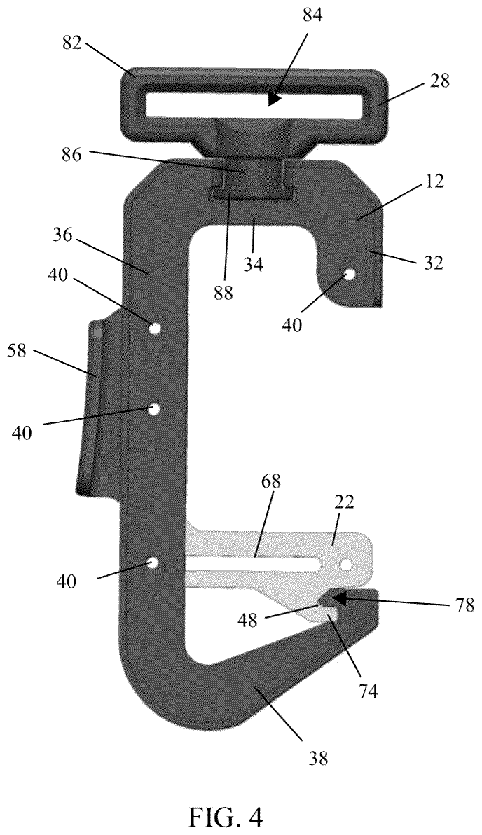

As seen in FIGS. 3 and 4, the projection 74 of the crossbar 22 and the projection 48 at the delimiting end of the fourth arm 38 of the chassis 12 are configured to interact with each other to form an interference fit in the first, locked position. The interlocking of the crossbar 22 with the chassis 12 below the swing arm 14 distributes a load equally along both sides of the chassis 12 in the first, locked position.

As can be seen in FIG. 2, the first spring 18 extends over the projection 60 of the release arm 16 and the projection 42 of the chassis. The first spring 18 can, for example, be a compression spring. In an alternate embodiment, a coil spring can be contactable with the release arm 16 and fixed within the clip 10 by a fastener.

As shown in FIG. 2, the second spring 20 can be fixed to the chassis 12 and contactable with the swing arm 14. Here, the spring 20 can be, for example, a swing arm spring. Alternatively, the second spring 20 can be a coil spring that is contactable with the swing arm 14.

The first spring 18 and the second spring 20 ensure that when no force is applied to the release arm 16 and the swing arm 14, respectively, that the release arm 16 and the swing arm 14 remain in a closed or locked position.

To unlock the clip 10, a force is applied the release arm 16 in a first direction and a force can then or simultaneously applied the swing arm 14 in a second direction that is opposite that of the release arm 16. When a force is applied to the release arm 16 and the swing arm 14, the first spring 18 and the second spring 20 compress and allow both the swing arm 14, the crossbar 22 and the release arm 16 to move and in turn create a gap between the lower end of the swing arm 14 and the angled projection 48 of the chassis 12 to allow an object to be inserted or removed within the clip 10. When no force is applied to the release arm 16, the swing arm 14 will not be able to move further in a direction toward the release arm 16 to create a larger gap and when a force is no longer applied to the swing arm 14 as well, the clip 10 will returns to the first closed or locked position.

The first shroud 24 extends substantially over a first side of the chassis 12 and is fixed thereto by one or more fasteners, and the second shroud 26 extends substantially over a second side of the chassis 12 and is fixed thereto by one or more fasteners.

The rotatable attachment 28 is arranged within the recess 44 that extends from an external surface of the second arm 34 of the main body 30 inwardly and can swivel or rotate within the recess 44, as desired. The attachment 28 includes a handle 82 with an opening 84 that an object such as a rope, leash, etc., can extend through and be fixed to the clip 10, a neck 86 that extends from the handle 82 and a circular disk 88 that extends from the neck 86.

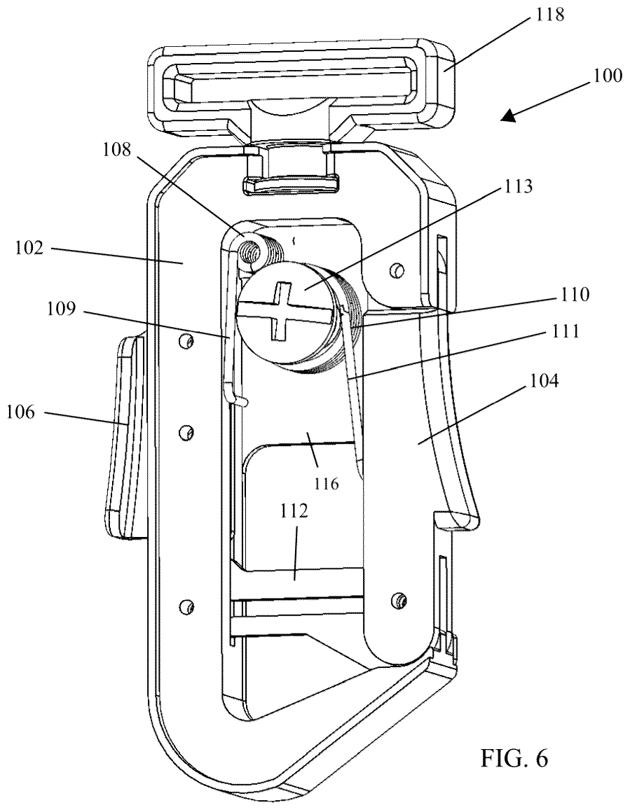

FIG. 6 illustrates another embodiment of a clip assembly 100. The clip assembly 100 includes several like parts to the clip assembly 10. The clip assembly 100 includes a chassis or housing 102, a swing arm 104 pivotably fixed to the chassis 102, a release arm 106 that is pivotably fixed to the chassis 102, a first spring 108 that is fixed in place by a fastener (not shown), a second spring 110 that is fixed by a second fastener 113, a crossbar 112 that is fixed to the swing arm 104 and slidably fixed to the chassis 112, a first shroud (not shown) that extends over a first side of the chassis 102, a second shroud 116 that extends over a second side of the chassis 102 and an rotatable attachment 118.

As can be seen in FIG. 6, the first spring 108 and the second spring 110 are coil springs. The first spring 108 is arranged within the clip assembly 100 and has an arm 109 that extends in a first direction and is configured to contact and apply a force to the release arm 106. The second spring 110 has an arm 111 that extends in a second direction and is configured to apply a force on the swing arm 104. The springs 108, 110 are configured to ensure the clip 100 remains in a closed position when a force is not applied thereto, but allow for movement of the swing arm 104, the release arm 106 and the cross bar 112 upon a force being applied to the release arm 106 and swing arm 104.

To unlock the clip 100, a force is applied the release arm 106 in a first direction and a force can then or simultaneously applied the swing arm 104 in a second direction that is opposite that of the release arm 106. When a force is applied to the release arm 106 and the swing arm 104, the first spring 108 and the second spring 110 compress and allow both the swing arm 104, the crossbar 112 and the release arm 106 to move and in turn create a gap between the lower end of the swing arm 104 and the chassis 102 to allow an object to be inserted or removed within the clip 100. When no force is applied to the release arm 106, the swing arm 104 will not be able to move further in a direction toward the release arm 106 to create a larger gap and when a force is no longer applied to the swing arm 104 as well, the clip 100 will returns to the first closed or locked position.

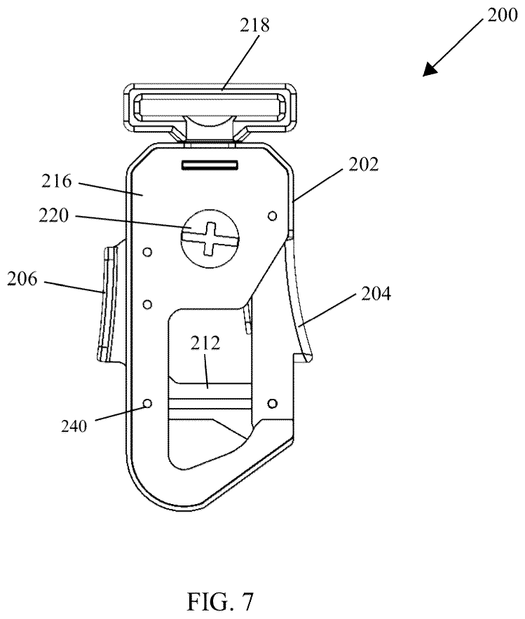

FIGS. 7-22 illustrates various views of yet another embodiment of a clip assembly 200. The clip assembly 200 includes several like parts as the clip assemblies 10 and 100. The interaction between the parts and details thereto, with the exception of the details discussed below with respect to the spring 208, are the same as the clip assemblies 10 and 100.

The clip assembly 200 includes a chassis or housing 202, a swing arm 204 that is pivotably fixed to the chassis 202, a release arm 206 that is pivotably fixed to the chassis 202, a spring 208 that is fixed in place by a fastener 220, a crossbar 212 that is fixed to the swing arm 204 and slidably fixed to the chassis 212, a first shroud 214 that extends over a first side of the chassis 202, a second shroud 216 that extends over a second side of the chassis 202 and a rotatable attachment 218.

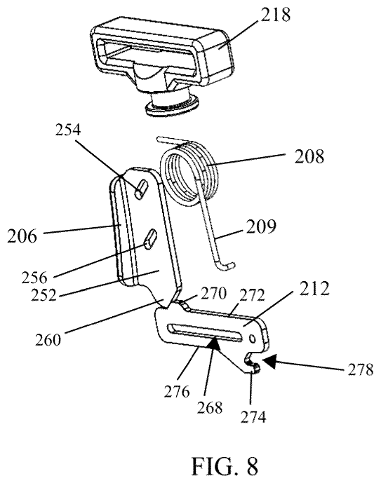

As can be seen, for example, in FIG. 8-10, the spring 208 and is a coil spring. The coil spring 208 is arranged within the clip assembly 200 and has an arm 209 that is configured to contact and apply a force to the swing arm 204. The spring 208 is configured to ensure that the clip 200 remains in a closed position when a force is not applied thereto, but allow for movement of the swing arm 204, the release arm 206 and the crossbar 212 upon a force being applied to the release arm 206 and swing arm 204.

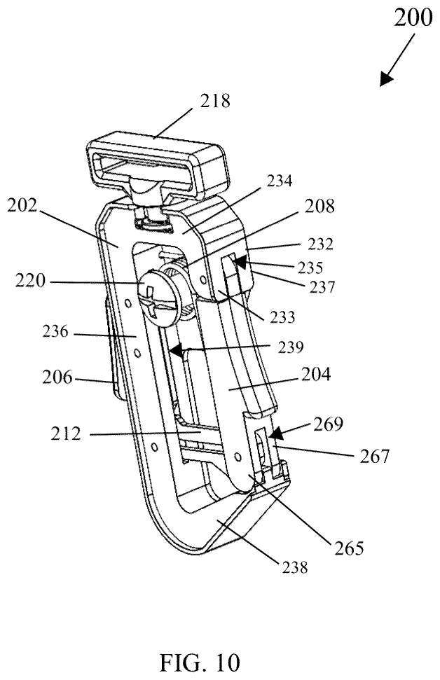

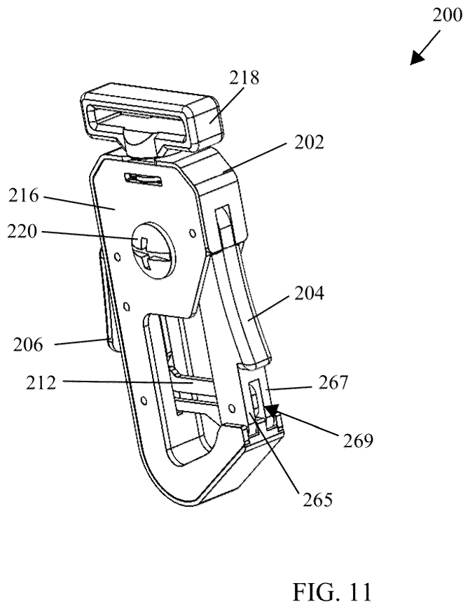

As shown in FIGS. 10-11, the chassis 202 is generally C-shaped as defined by a first arm 232 that includes a first projection 233 and a second projection 235 that are spaced from each other forming a gap 237 therebetween and delimit the first arm 232 at a first end of the chassis 202, a second arm 234 that is contiguous to the first arm 232 and extends at an angle therefrom, a third arm 236 that is spaced from the first arm 232 and extends at an angle from the second arm 234 substantially parallel to the first arm 232, and a fourth arm 238 that extends at an angle from the third arm 236. The second arm 234 includes an opening 239 in which the swing arm 214 the crossbar 222 are in part arranged. A delimiting end of the fourth arm 238 includes an angled projection that extends toward the third arm with a cavity located directly beneath the angled projection. A plurality of through-holes 240 extend through the chassis 202.

As seen, for example, in FIG. 8, the release arm 206 includes a main body 252 with a first projection 254 and a second projection 256 and a first projection 260 that extends from the main body 52. The release arm 206 is rotatably fixed to the chassis 202.

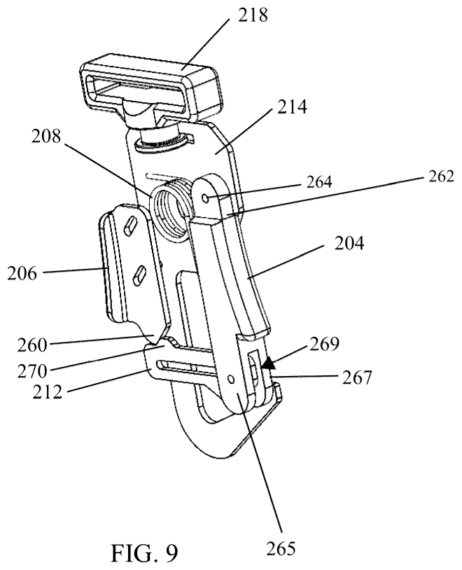

As seen, for example, in FIG. 9, the swing arm 204 includes a main body 262 with an opening 264 though which fasteners (e.g., steel pins) extend to rotatably fix the swing arm 214 to the chassis 202, a first projection 265 and a second projection 267 that are spaced from each other forming a gap 269 therebetween to allow the crossbar 212 to be arranged and fixed within the gap 269.

As seen, for example, in FIG. 8, the crossbar 212 includes a slotted opening 268 therein, a projection 270 (e.g., trapezoidal shape) extends from an outer edge of a top surface 272 and a projection 274 extends from an outer edge of the lower surface 276 of the crossbar 212 forming a cavity 278 between the outer edge of the lower surface 276 and the projection 274. The crossbar 212 is fixed to the swing arm 204 by a fastener (e.g., steel pin), and configured to extend through an opening in chassis 202 and the swing arm 204 (see FIG. 3). The crossbar 212 prohibits motion of the swing arm 204 and the release arm 206 in the first closed or locked state.

The projection 274 of the crossbar 212 and a projection at the delimiting end of the fourth arm 238 of the chassis 212 are configured to interact with each other to form an interference fit in the first, locked position. The interlocking of the crossbar 212 with the chassis 202 below the swing arm 204 distributes a load equally along both sides of the chassis 202 in the first, locked position.

To unlock the clip 200, a force is applied the release arm 206 in a first direction and a force can then or simultaneously applied the swing arm 204 in a second direction that is opposite that of the release arm 206. When a force is applied to the release arm 206 and the swing arm 204, the spring 208 compresses and allow both the swing arm 204, the crossbar 212 and the release arm 206 to move and in turn create a gap between the lower end of the swing arm 204 and the chassis 202 to allow an object to be inserted or removed within the clip 200. When no force is applied to the release arm 206, the swing arm 204 will not be able to move further in a direction toward the release arm 206 to create a larger gap and when a force is no longer applied to the swing arm 204 as well, the clip 200 will returns to the first closed or locked position.

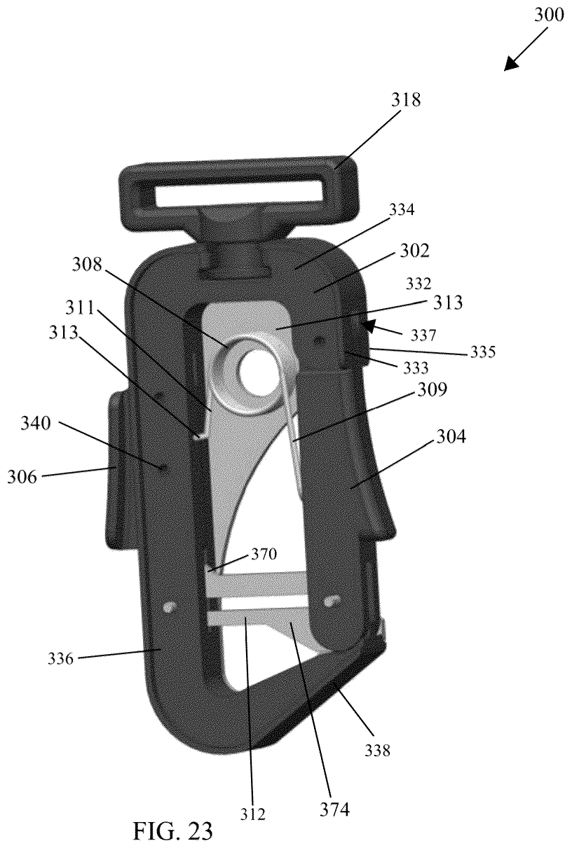

FIG. 23-25 illustrate another embodiment of a clip assembly 300. The clip assembly 300 includes several like parts to the clip assemblies 10, 100, 200. The interaction between the parts and details thereto, with the exception of the details discussed below with respect to the springs 308, 310 and associated components are the same as the clip assemblies 10, 100, 200.

The clip assembly 300 includes a chassis or housing 302, a swing arm 304 pivotably fixed to the chassis 302, a release arm 306 that is pivotably fixed to the chassis 302, a spring 308 that is fixed in place by a fastener (not shown), a crossbar 312 that is fixed to the swing arm 304 and slidably fixed to the chassis 212, a first shroud (not shown) that extends over a first side of the chassis 302, a second shroud 313 that extends over a second side of the chassis 302 and a rotatable attachment 318.

As can be seen in FIG. 23-25, the spring 308 is a coil spring. The coil spring 308 is arranged within the clip assembly 300. The coil spring 308 has a first arm 309 with a first projection that extends from the first arm 309 that extends from a first end of the spring 308 and that is configured to contact and that is configured to apply a force to the release arm 306. The coil spring 308 has a second arm 311 with a second projection 313 that extends from a second end of the spring 308 and that is configured to apply a force on the swing arm 304.

The spring 308 is configured to ensure the clip 300 remains in a closed position when a force is not applied thereto, but allow for movement of the swing arm 304, the release arm 306 and the cross bar 312 upon a force being applied to the release arm 306 and swing arm 304.

As shown in FIGS. 23-25, the chassis 302 is generally C-shaped as defined by a first arm 332 that includes a first projection 333 and a second projection 335 that are spaced from each other forming a gap 337 therebetween and delimit the first arm 332 at a first end of the chassis 302, a second arm 334 that is contiguous to the first arm 332 and extends at an angle therefrom, a third arm 336 that is spaced from the first arm 332 and extends at an angle from the second arm 334 substantially parallel to the first arm 332, and a fourth arm 338 that extends at an angle from the third arm 336. The second arm 334 includes an opening 339 in which the swing arm 314 the crossbar 322 are in part arranged. A delimiting end of the fourth arm 338 includes an angled projection that extends toward the third arm with a cavity located directly beneath the angled projection. A plurality of through-holes 340 extend through the chassis 302.

The release arm 306 includes a projection (not shown). The crossbar 312 includes a slotted opening 368 therein, a first projection 370 (e.g., trapezoidal shape) and a second projection 374. The crossbar 312 is fixed to the swing arm 304 by a fastener (e.g., steel pin), and configured to extend through an opening in chassis 302 and the swing arm 304. The crossbar 312 prohibits motion of the swing arm 304 and the release arm 306 in the first closed or locked state.

The projection 374 of the crossbar 312 and a projection at the delimiting end of the fourth arm 338 of the chassis 312 are configured to interact with each other to form an interference fit in the first, locked position. The interlocking of the crossbar 312 with the chassis 302 below the swing arm 304 distributes a load equally along both sides of the chassis 302 in the first, locked position.

To unlock the clip 300, a force is applied the release arm 306 in a first direction and a force can then or simultaneously applied the swing arm 304 in a second direction that is opposite that of the release arm 306. When a force is applied to the release arm 306 and the swing arm 304, the spring 308 compresses and allow both the swing arm 304, the crossbar 312 and the release arm 306 to move and in turn create a gap between the lower end of the swing arm 304 and the angled projection of the chassis 302 to allow an object to be inserted or removed within the clip 300. When no force is applied to the release arm 306, the swing arm 304 will not be able to move further in a direction toward the release arm 306 to create a larger gap and when a force is no longer applied to the swing arm 304 as well, the clip 300 will returns to the first closed or locked position.

The components of the clip 300 can, for example, be manufactured by injection molding, carbon fiber, etc. components can also be stainless steel as well as other high strength materials. The combination of materials such as carbon fiber and stainless steel allow for the clip 300 to be both robust in strength and light-weight.

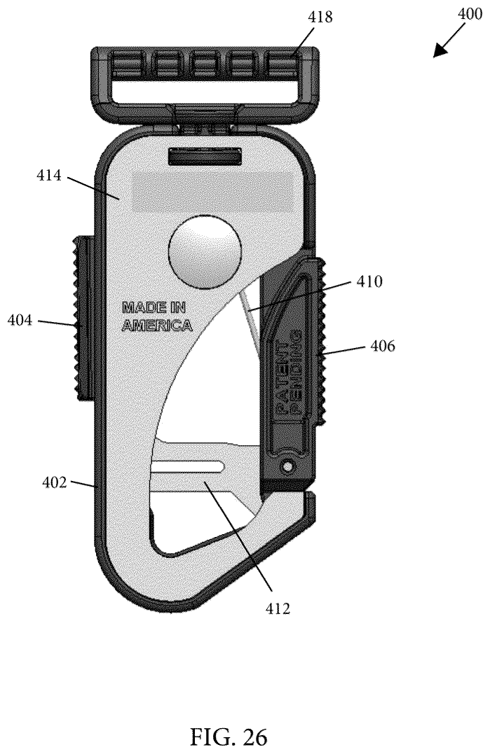

As can be seen in FIGS. 26-32, the clip 400 includes a chassis or housing 402, a swing arm 404 that is pivotably fixed to the chassis 402, a release arm 406 that is pivotably fixed to the chassis 402, a first spring 408 that is fixed at a first end to the chassis 402 and in contact with the release arm 406 at a second end thereof, a second spring 410 that is fixed at a first end to the chassis 402 and in contact with the swing arm 404 at a second end thereof, a crossbar 412 that is slidably fixed to the chassis 402 and fixed to the swing arm 404, a first shroud 414 that extends over a first side of the chassis 402, a second shroud 416 that extends over a second side of the chassis 402 and a rotatable attachment 418.

As shown in FIGS. 26-29, the chassis 402 is generally C-shaped as defined by a first arm 418 that includes a first projection 419 and a second protrusion 421 that are spaced from each other forming a gap 423 therebetween and delimit the first arm 418 at a first end of the chassis 402, a second arm 420 that is contiguous to the first arm 418 and extends at an angle therefrom, a third arm 422 that is spaced from the first arm 418 and extends at an angle from the second arm 420, substantially parallel to the first arm 418, and a fourth arm 424 that extends at an angle from the third arm 422. The second arm 420 includes an opening 425 in which the swing arm 404 is arranged and a slot 427 in which the crossbar 412 is arranged and slidably fixed to the chassis 402.

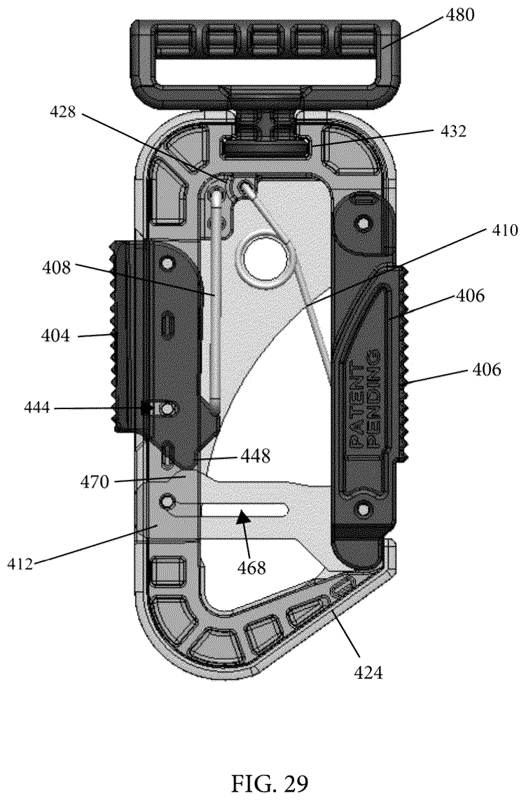

A plurality of through-holes 426 extend through the chassis 402. A projection 428 extends from the chassis 402 and includes a plurality of openings 430. A recess 432 extends from an external surface 434 of the second arm 420 inwardly. A delimiting end of the fourth arm 424 includes an angled projection 436 that extends toward the third arm 422 with a cavity 438 (see FIG. 29) located directly beneath the angled projection 436.

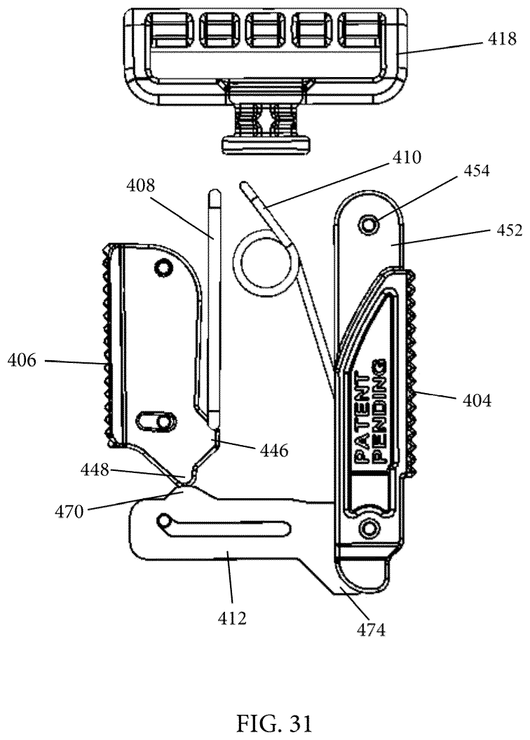

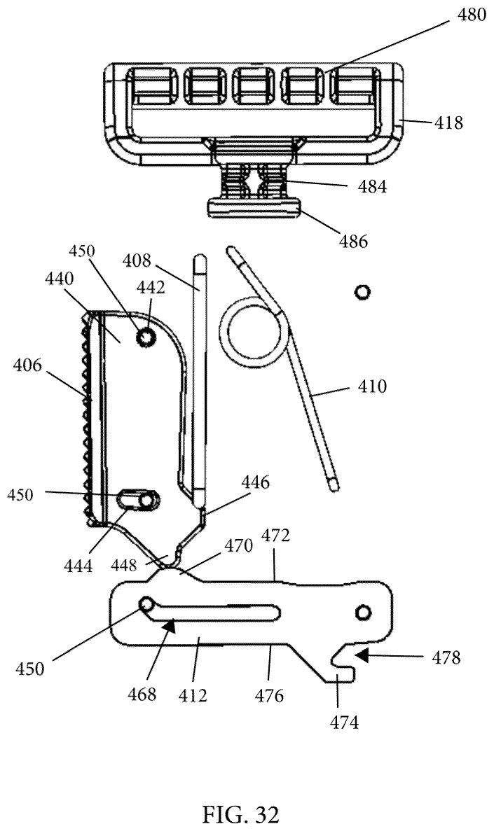

As seen, for example, in FIGS. 31, 32, the release arm 406 includes a main body 440 with an opening 442 and a slot 444, a first projection 446 that extends from the main body 440 of the release arm 406 in a first direction and a second projection 448 that extends from the main body 440 of the release arm 406 in a second direction. The release arm 406 is rotatably fixed to the chassis 402 by fasteners (e.g., steel pins) 450 that extend through the opening 442 and the slot 444.

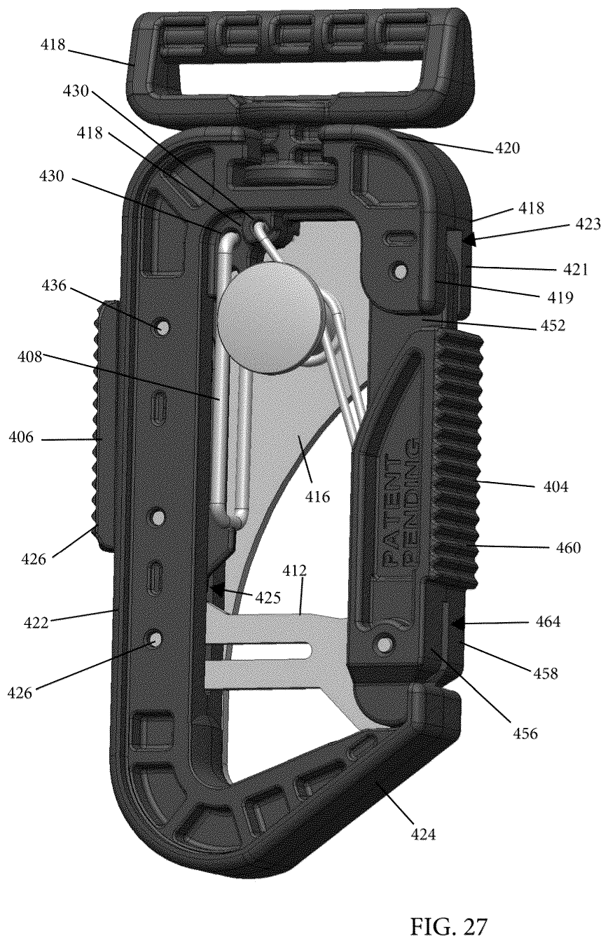

As seen, for example, in FIGS. 27, 28 and 30, the swing arm 404 includes a main body 452 that is delimited at a first end which is arrangeable within the gap 423 between the first and second projections 419, 421 of the first arm 418 of the chassis 402 and a first opening 454 that is spaced from the first end though which a fastener (e.g., steel pins) 450 extends to rotatably fix the swing arm 404 to the chassis 402. A first arm 456 extends from a first side of the main body 454 and a second arm 458 extends from a second side of the main body 454. The arms 456, 458 form a contact surface 460 on an external surface of the swing arm 404 and a first groove 462 an internal surface of the swing arm 404 in which the second spring 410 is arranged and contactable with the swing arm 404. The main body 452 and the arms 456, 458 form a second groove 464 at a second end of the swing arm 404 in which the crossbar 412 is arranged. A second opening 456 extend through the swing arm near the second end thereof and through which another one of the fasteners 450 extends to fix the swing arm 404 to the crossbar 412. The second end of the swing arm 404 contacts an inner surface of the fourth arm 424 in a first, closed position, and the second groove 464 is configured such that the angled projection 436 of the fourth arm 424 extends within the second groove 464 in the first, closed position.

As seen, for example, in FIGS. 29-32, the crossbar 412 includes a slotted opening 468 therein, a first projection 470 (e.g., trapezoidal shape) extends from an outer edge of a top surface 472 and a second projection 474 extends from an outer edge of the lower surface 476 of the crossbar 412 forming a cavity 478. The crossbar 412 prohibits motion of the swing arm 404 in the first closed, position.

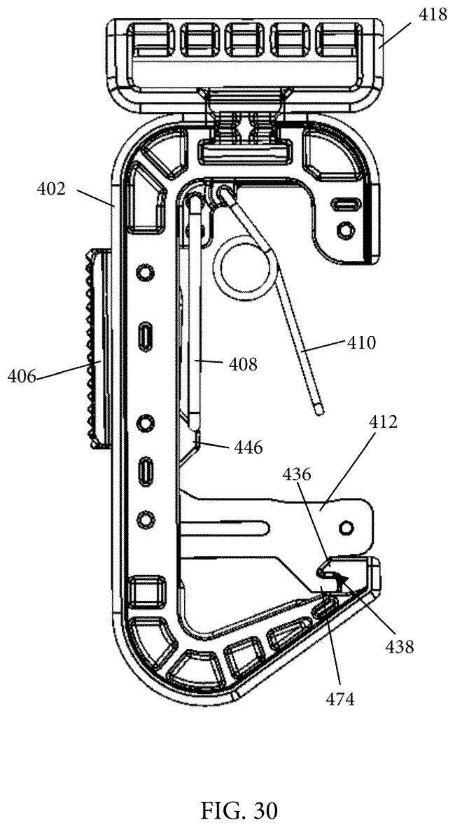

As seen in FIG. 30, the second projection 474 of the crossbar 412 and the projection 436 at the delimiting end of the fourth arm 424 of the chassis 402 are configured to interact with each other to form an interference fit in the first, closed position. The interlocking of the crossbar 412 with the chassis 402 near the distal end the swing arm 404 distributes a load equally along both sides of the chassis 402 in the first, closed position.

As can be seen in FIGS. 27-32, the first spring 408 which can, for example, be a compression spring, is delimited at a first end and a second end and extends to form a U-Shape between the first and second end of the spring 408 which contacts and remains in contact with the release arm 406. The first end of the first spring 408 is fixed within a first side of a first one of the openings 430 of the projection 428 that extends from the crossbar 412 and the second end of the first spring 408 is fixed within a second side of a first one of the openings 430 of the projection that extends from the crossbar 412. The second spring 410, which can, for example, be a compression spring, is delimited at a first end and a second end and extends to form a U-Shape between the first and second end of the spring 410, which contacts and remains in contact with the swing arm 404. The first end of the second spring 410 is fixed within a second one of the openings 430 of the projection 428 that extends from the crossbar 412 and the second end of the second spring 410 is fixed within a third one of the openings 430 of the projection 428 that extends from the crossbar 412.

The first spring 408 and the second spring 410 ensure that when no force is applied to the release arm 406 and the swing arm 404, respectively, that the release arm 406 and the swing arm 404 remain in a closed or locked position.

To unlock the clip 400, a force is applied the release arm 406 in a first direction and a force can then or simultaneously applied the swing arm 404 in a second direction that is opposite that of the release arm 406. When a force is applied to the release arm 406 and the swing arm 404, the first spring 408 and the second spring 410 compress and allow both the swing arm 404, the crossbar 412 and the release arm 406 to move and in turn create a gap between the lower end of the swing arm 404 and the angled projection 436 of the chassis 412 to allow an object to be inserted or removed within the clip 400. When no force is applied to the release arm 406, the swing arm 404 will not be able to move further in a direction toward the release arm 406 to create a larger gap and when a force is no longer applied to the swing arm 404 as well, the clip 400 will return to the first closed or locked position.

The first shroud 414 extends substantially over a first side of the chassis 412 and is fixed thereto by one or more fasteners, and the second shroud 416 extends substantially over a second side of the chassis 412 and is fixed thereto by one or more fasteners.

The rotatable attachment 418 is arranged within the recess 432 that extends from an external surface of the second arm 434 of the chassis 412 inwardly and can swivel or rotate within the recess 434, as desired. The attachment 418 includes a handle 480 with an opening 482 that an object such as a rope, leash, etc., can extend through and be fixed to the clip 400, a neck 484 that extends from the handle 480 and a circular disk 486 that extends from the neck 484.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. It is to be understood that the phraseology or terminology employed herein is for the purpose of description and not of limitation. In addition, while several variations of the embodiments of the invention have been shown and described in detail, other modifications, which are within the scope of this invention, including, but not limited to, the substitutions of equivalent features, materials, or parts, will be readily apparent to those of skill in the art based upon this disclosure without departing from the spirit and scope of the invention.

What is claimed is:

1. A clip, comprising:
a housing;
a first arm pivotally fixed to the housing;
a second arm pivotally fixed to the housing;
at least one spring fixed within housing and configured to apply a force to the first arm and the second arm; and
a crossbar fixed to the first arm and contactable with the second arm.

2. The clip of claim 1, wherein the at least one spring includes a first spring and a second spring.

3. The clip of claim 2, wherein the first spring is fixed to the chassis and in contact with the first arm and the second spring is fixed to the chassis and in contact with the second arm.

4. The clip of claim 1, wherein the crossbar is slidably fixed to the housing and fixed to the swing arm.

5. The clip of claim 1, wherein a first shroud that extends over a first side of the housing and a second shroud that extends over a second side of the housing.

6. The clip of claim 1, further comprising a rotatable attachment.

7. The clip of claim 1, wherein the housing is comprised of a first arm, a second arm that is contiguous to the first arm and extends at an angle from the first arm, a third arm that is spaced from the first arm and extends at an angle from the second arm, and a fourth arm that extends at an angle from the third arm.

8. The clip of claim 7, wherein the first arm of the housing includes a first projection and second projections that are spaced from each other forming a gap therebetween.

9. The clip of claim 7, wherein the fourth arm of the housing includes an angled projection that extends toward the third arm with a cavity beneath the angled projection.

10. The clip of claim 1, wherein the crossbar includes a first projection that extends from an outer edge in a first direction and a second projection that extends from an outer edge in a second direction.

11. The clip of claim 1, wherein the first arm includes a first projection that extends in a first direction and a second projection that extends in a second direction.

12. The clip of claim 10, wherein the first arm includes a first projection that extends in a first direction and a second projection that extends in a second direction with the first projection of the crossbar arranged to be in contact with the second projection of the first arm and the first spring arranged to be in contact with the first projection of the first projection of the first arm.

13. The clip of claim 1, wherein the first spring and the second spring are fixed to the housing.

14. The clip of claim 1, wherein the first arm is a swing arm and the second arm is a release arm.

15. A method of locking and unlock a clip, comprising the steps of:
providing the clip comprising a housing, a first arm pivotally fixed to the housing, a second arm pivotally fixed to the housing, at least one spring fixed within housing and configured to apply a force to the first arm and the second arm and a crossbar fixed to the first arm and contactable with the second arm;
applying a force to the first arm in a first direction and a force to the second arm in a second direction that is opposite that of the force applied to the first arm;
continuing to apply the force to create an opening between the second arm and the housing;
releasing the force applied to the first arm and the second arm which in turn caused the first arm, the second arm, the at least one spring and the crossbar to return to a resting state and close the opening between the second arm and the housing.
